(19) United States
(12) Patent Application Publication
(10) Pub. No.: US 2018/0332356 A1
(43) Pub. Date: Nov. 15, 2018

(54) Method and System for Implementing Unified Multi-Source Video Programming & Navigation Guide

(71) Applicant: CenturyLink Intellectual Property LLC, Denver, CO (US)

(72) Inventors: Zubin Ingah, Centennial, CO (US); Fernando Prieto-Ochoa, Denver, CO (US); Asghar Hussain, Parker, CO (US); Pavan Sudheer, Denver, CO (US); Michael D. Sprenger, Boulder, CO (US)

(21) Appl. No.: 15/840,770

(22) Filed: Dec. 13, 2017

Related U.S. Application Data
(60) Provisional application No. 62/503,403, filed on May 9, 2017.
(60) Provisional application No. 62/512,413, filed on May 30, 2017.

(51) Int. Cl. H04N 21/482; H04N 21/462; H04N 21/472; H04N 21/422; H04N 5/44

(52) U.S. Cl. CPC H04N 21/4821; H04N 21/4622; H04N 5/4403; H04N 21/42204; H04N 21/47205

(57) ABSTRACT

Novel tools and techniques are provided for implementing a unified multi-source video programming & navigation guide. In various embodiments, a computing system might receive first metadata, receive second metadata, and compile the first metadata and the second metadata. The first metadata might correspond to first video content available from a first video content source among a plurality of video content sources, while the second metadata might correspond to second video content available from a second video content source among the plurality of video content sources. The computing system might also generate a unified multi-source video programming and navigation guide (“UPG”) that lists in a blended fashion the first video content and the second video content, based at least in part on the first metadata and the second metadata. The computing system might display the UPG on a display screen of a display device.

### CROSS-REFERENCES TO RELATED APPLICATIONS

This application claims priority to U.S. Patent Application Ser. No. 62/503,403 (the “'403 Application”), filed May 9, 2017 by Zubin Ingah et al. (attorney docket no. 020370-033501US), entitled, “Unified Multi-Source Video Programming & Navigation Guide,” and U.S. Patent Application Ser. No. 62/512,413 (the “'413 Application”), filed May 30, 2017 by Michael D. Sprenger et al. (attorney docket no. 020370-033901US), entitled, “Conflict Resolution Mechanism for Electronic Program Guides,” the disclosure of each of which is incorporated herein by reference in its entirety for all purposes.

This application may be related to U.S. patent application Ser. No. 15/840,982 (the “'982 application”), filed concurrent herewith (attorney docket no. 020370-033900US), entitled, “Method and System for Implementing Conflict Resolution for Electronic Program Guides,” which also claims priority to the '403 and '413 Applications.

The respective disclosures of these applications/patents (which this document refers to collectively as the “Related Applications”) are incorporated herein by reference in their entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing media content navigation and presentation, and, more particularly, to methods, systems, and apparatuses for implementing a unified multi-source video programming & navigation guide.

### BACKGROUND

Conventional electronic program guides (“EPGs”) only cover one type or input signal source. In other words, conventional EPGs do not provide a display that integrates or unifies metadata for video content from a plurality of different sources (e.g., video streaming sources, video broadcast sources, off the air or over the air (“OTA”) sources, satellite television (“TV”) sources, cable TV sources, third party video content sources, etc.).

Hence, there is a need for more robust and scalable solutions for implementing media content navigation and presentation, and, more particularly, to methods, systems, and apparatuses for implementing a unified multi-source video programming & navigation guide.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a schematic diagram illustrating a system for implementing a unified multi-source video programming & navigation guide, in accordance with various embodiments.

FIGS. 2A and 2B are schematic diagrams illustrating various systems for implementing a unified multi-source video programming & navigation guide, in accordance with various embodiments.

FIG. 3 is a schematic diagram illustrating a system for implementing a unified multi-source video programming & navigation guide, in accordance with various embodiments.

FIGS. 4A-4C are flow diagrams illustrating a method for implementing a unified multi-source video programming & navigation guide, in accordance with various embodiments.

FIG. 5 is a block diagram illustrating an exemplary computer or system hardware architecture, in accordance with various embodiments.

FIG. 6 is a block diagram illustrating a networked system of computers, computing systems, or system hardware architecture, which can be used in accordance with various embodiments.

### DETAILED DESCRIPTION OF CERTAIN EMBODIMENTS

Overview

Various embodiments provide tools and techniques for implementing media content navigation and presentation, and, more particularly, to methods, systems, and apparatuses for implementing a unified multi-source video programming & navigation guide (herein referred to simply as unified programming guide (“UPG”)).

In various embodiments, a computing system might receive one or more first metadata (e.g., from one or more of the metadata sources and corresponding data stores), receive one or more second metadata (e.g., from one or more others of the metadata sources and corresponding data stores), and compile the one or more first metadata and the one or more second metadata. The one or more first metadata might correspond to one or more first video content available from a first video content source among a plurality of video content sources, while the one or more second metadata might correspond to one or more second video content available from a second video content source among the plurality of video content sources. The computing system might also generate a unified multi-source video programming and navigation guide (“UPG”) that lists in a blended fashion the one or more first video content and the one or more second video content, based at least in part on the one or more first metadata and the one or more second metadata. The computing system might further display the UPG on a display screen of a display device.

In some cases, the UPG might present the blended listing of the one or more first video content and the one or more second video content in a grid with at least one of channel, video content source, or video content along a first axis of the grid and with start times along a second axis of the grid. In some embodiments, the computing system might include, without limitation, one of a set-top box (“STB”), a digital video recording (“DVR”) device, a processor of the display device running a software application (“app”), a processor of a user device running an app, a server computer over a network, a cloud-based computing system over a network, a media player, or a gaming console, and/or the like. In some cases, the plurality of video content sources might include, but is not limited to, at least two of one or more video streaming sources, one or more video broadcast sources, one or more off the air (“OTA”) sources, one or more satellite television (“TV”) sources, one or more cable TV sources, or one or more third party video content sources, and/or the like. In some instances, each of the one or more first metadata, the one or more second metadata, and the one or more third metadata is received by the computing system in response to one of a pull data distribution instruction or a push data distribution instruction.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Various embodiments described herein, while embodying (in some cases) software products, computer-performed methods, and/or computer systems, represent tangible, concrete improvements to existing technological areas, including, without limitation, media content streaming or downloading technology, media content navigation or selection technology, user interface technology and/or the like. In other aspects, certain embodiments, can improve the functioning of user equipment or systems themselves (e.g., media players, set-top boxes (“STBs”), media content streaming or downloading systems, etc.), for example, by receiving, with a computing system, one or more first metadata, the one or more first metadata corresponding to one or more first video content available from a first video content source among a plurality of video content sources; receiving, with the computing system, one or more second metadata, the one or more second metadata corresponding to one or more second video content available from a second video content source among the plurality of video content sources, the second video content source being of a different type from that of the first video content source; compiling, with the computing system, the one or more first metadata and the one or more second metadata; generating, with the computing system, a unified multi-source video programming and navigation guide (“UPG”) that lists in a blended fashion the one or more first video content and the one or more second video content, based at least in part on the one or more first metadata and the one or more second metadata, the UPG presenting the blended listing of the one or more first video content and the one or more second video content in a grid with at least one of channel, video content source, or video content along a first axis of the grid and with start times along a second axis of the grid; and displaying, with the computing system, the UPG on a display device; and/or the like. In particular, to the extent any abstract concepts are present in the various embodiments, those concepts can be implemented as described herein by devices, software, systems, and methods that involve specific novel functionality (e.g., steps or operations), such as, compiling, with the computing system, the one or more first metadata and the one or more second metadata; generating, with the computing system, a UPG that lists in a blended fashion the one or more first video content and the one or more second video content, based at least in part on the one or more first metadata and the one or more second metadata, the UPG presenting the blended listing of the one or more first video content and the one or more second video content in a grid with at least one of channel, video content source, or video content along a first axis of the grid and with start times along a second axis of the grid; displaying, with the computing system, the UPG on a display device; and and/or the like, to name a few examples, that extend beyond mere conventional computer processing operations. These functionalities can produce tangible results outside of the implementing computer system, including, merely by way of example, optimized presentation and navigation of media content (including video content) to the user thus providing for smoother and more efficient navigation of video content from multiple sources by the user, and/or the like, at least some of which may be observed or measured by customers and/or service providers.

In an aspect, a method might comprise receiving, with a computing system, one or more first metadata, the one or more first metadata corresponding to one or more first video content available from a first video content source among a plurality of video content sources; receiving, with the computing system, one or more second metadata, the one or more second metadata corresponding to one or more second video content available from a second video content source among the plurality of video content sources, the second video content source being of a different type from that of the first video content source; and compiling, with the computing system, the one or more first metadata and the one or more second metadata. The method might also comprise generating, with the computing system, a unified multi-source video programming and navigation guide (“UPG”) that lists in a blended fashion the one or more first video content and the one or more second video content, based at least in part on the one or more first metadata and the one or more second metadata, the UPG presenting the blended listing of the one or more first video content and the one or more second video content in a grid with at least one of channel, video content source, or video content along a first axis of the grid and with start times along a second axis of the grid. The method might further comprise displaying, with the computing system, the UPG on a display device.

In some embodiments, the computing system might comprise one of a set-top box (“STB”), a digital video recording (“DVR”) device, a processor of the display device running a software application (“app”), a processor of a user device running an app, a server computer over a network, a cloud-based computing system over a network, a media player, or a gaming console, and/or the like. In some cases, the display device might comprise one of a television set, a smart television, a computer monitor, a laptop monitor, or a projection system, and/or the like. In some instances, the plurality of video content sources might comprise at least two of one or more video streaming sources, one or more video broadcast sources, one or more off the air (“OTA”) sources, one or more satellite television (“TV”) sources, one or more cable TV sources, or one or more third party video content sources, and/or the like.

According to some embodiments, each of the one or more first metadata and the one or more second metadata is received by the computing system in response to one of a pull data distribution instruction or a push data distribution instruction, or the like. In some instances, the UPG is updated or refreshed in response to a trigger, the trigger comprising one of power-up of the computing system, boot-up of the computing system, wake-up of the computing system, periodic update timer, or user request operator instruction, and/or the like.

In some embodiments, the method might further comprise receiving, with the computing system, first user input from a user, the first user input causing the UPG being displayed on the display device in a particular order or grouping; updating, with the computing system, the UPG in accordance with the particular order or grouping; and displaying, with the computing system, the updated UPG on the display device. In some cases, the particular order or grouping might be based on one of channel numbers, station names, genre groupings, favorites groupings, or a combination of one or more of channel numbers, station names, genre groupings, or favorites groupings, and/or the like.

According to some embodiments, the method might further comprise receiving, with the computing system, second user input from a user, the second user input comprises a selection of a video content from among the blended listing of the one or more first video content and the one or more second video content of the UPG; in response to receiving the second user input, determining, with the computing system, which video content source of the one or more first video content sources or the one or more second video content sources corresponds to the selected video content in accordance with the second user input; based on the determined video content source, accessing, with the computing system, the selected video content from the determined video content source; and displaying, with the computing system, the selected video content on the display device. In some instances, receiving second user input from the user might comprise receiving, with the computing system, the second user input from the user via one or more user devices. The one or more user devices might each comprise one of a laptop computer, a tablet computer, a smart phone, a mobile phone, a personal digital assistant, a remote control device, or a portable gaming device, and/or the like.

Merely by way of example, the method might further comprise receiving, with the computing system, one or more third metadata, the one or more third metadata corresponding to one or more third video content available from a third video content source among the plurality of video content sources, the third video content source being of a different type from that of each of the first video content source and the second video content source; and compiling, with the computing system, the one or more first metadata, the one or more second metadata, and the one or more third metadata. In some cases, generating the UPG might comprise generating, with the computing system, the UPG that lists in a blended fashion the one or more first video content, the one or more second video content, and the one or more third video content, based at least in part on the one or more first metadata, the one or more second metadata, and the one or more third metadata, the UPG presenting the blended listing of the one or more first video content, the one or more second video content, and the one or more third video content in the grid with at least one of channel, video content source, or video content along the first axis of the grid and with start times along the second axis of the grid.

In another aspect, an apparatus might comprise at least one processor and a non-transitory computer readable medium communicatively coupled to the at least one processor. The non-transitory computer readable medium might have stored thereon computer software comprising a set of instructions that, when executed by the at least one processor, causes the apparatus to: receive one or more first metadata, the one or more first metadata corresponding to one or more first video content available from a first video content source among a plurality of video content sources; receive one or more second metadata, the one or more second metadata corresponding to one or more second video content available from a second video content source among the plurality of video content sources, the second video content source being of a different type from that of the first video content source; compile the one or more first metadata and the one or more second metadata; generate a unified multi-source video programming and navigation guide (“UPG”) that lists in a blended fashion the one or more first video content and the one or more second video content, based at least in part on the one or more first metadata and the one or more second metadata, the UPG presenting the blended listing of the one or more first video content and the one or more second video content in a grid with at least one of channel, video content source, or video content along a first axis of the grid and with start times along a second axis of the grid; and display the UPG on a display device.

According to some embodiments, the apparatus might comprise one of a set-top box (“STB”), a digital video recording (“DVR”) device, a processor of the display device running a software application (“app”), a processor of a user device running an app, a server computer over a network, a cloud-based computing system over a network, a media player, or a gaming console, and/or the like. In some cases, the display device might comprise one of a television set, a smart television, a computer monitor, a laptop monitor, or a projection system, and/or the like. In some instances, the plurality of video content sources might comprise at least two of one or more video streaming sources, one or more video broadcast sources, one or more off the air (“OTA”) sources, one or more satellite television (“TV”) sources, one or more cable TV sources, or one or more third party video content sources, and/or the like.

In some embodiments, each of the one or more first metadata and the one or more second metadata is received by the computing system in response to one of a pull data distribution instruction or a push data distribution instruction, or the like. In some instances, the UPG is updated or refreshed in response to a trigger, the trigger comprising one of power-up of the computing system, boot-up of the computing system, wake-up of the computing system, periodic update timer, or user request operator instruction, and/or the like.

According to some embodiments, the set of instructions that, when executed by the at least one processor, might cause the apparatus to: receive first user input from a user, the first user input causing the UPG being displayed on the display device in a particular order or grouping; update the UPG in accordance with the particular order or grouping; and display the updated UPG on the display device. In some cases, the particular order or grouping might be based on one of channel numbers, station names, genre groupings, favorites groupings, or a combination of one or more of channel numbers, station names, genre groupings, or favorites groupings, and/or the like.

In some embodiments, the set of instructions that, when executed by the at least one processor, might cause the apparatus to: receive second user input from a user, the second user input comprises a selection of a video content from among the blended listing of the one or more first video content and the one or more second video content of the UPG; in response to receiving the second user input, determine which video content source of the one or more first video content sources or the one or more second video content sources corresponds to the selected video content in accordance with the second user input; based on the determined video content source, access the selected video content from the determined video content source; and display the selected video content on the display device. In some instances, receiving second user input from the user might comprise receiving, with the computing system, the second user input from the user via one or more user devices. The one or more user devices might each comprise one of a laptop computer, a tablet computer, a smart phone, a mobile phone, a personal digital assistant, a remote control device, or a portable gaming device, and/or the like.

Merely by way of example, the set of instructions that, when executed by the at least one processor, might cause the apparatus to: receive one or more third metadata, the one or more third metadata corresponding to one or more third video content available from a third video content source among the plurality of video content sources, the third video content source being of a different type from that of each of the first video content source and the second video content source; and compile the one or more first metadata, the one or more second metadata, and the one or more third metadata. In some cases, generating the UPG might comprise generating, with the computing system, the UPG that lists in a blended fashion the one or more first video content, the one or more second video content, and the one or more third video content, based at least in part on the one or more first metadata, the one or more second metadata, and the one or more third metadata, the UPG presenting the blended listing of the one or more first video content, the one or more second video content, and the one or more third video content in the grid with at least one of channel, video content source, or video content along the first axis of the grid and with start times along the second axis of the grid.

In yet another aspect, a system might comprise a computing system and a display device. The computing system might comprise at least one first processor and a first non-transitory computer readable medium communicatively coupled to the at least one first processor. The first non-transitory computer readable medium might have stored thereon computer software comprising a first set of instructions that, when executed by the at least one first processor, causes the computing system to: receive one or more first metadata, the one or more first metadata corresponding to one or more first video content available from a first video content source among a plurality of video content sources; receive one or more second metadata, the one or more second metadata corresponding to one or more second video content available from a second video content source among the plurality of video content sources, the second video content source being of a different type from that of the first video content source; compile the one or more first metadata and the one or more second metadata; generate a unified multi-source video programming and navigation guide (“UPG”) that lists in a blended fashion the one or more first video content and the one or more second video content, based at least in part on the one or more first metadata and the one or more second metadata, the UPG presenting the blended listing of the one or more first video content and the one or more second video content in a grid with at least one of channel, video content source, or video content along a first axis of the grid and with start times along a second axis of the grid; and send the UPG to a display device.

The display device might comprise a display screen, at least one second processor, and a second non-transitory computer readable medium communicatively coupled to the at least one second processor. The second non-transitory computer readable medium might have stored thereon computer software comprising a second set of instructions that, when executed by the at least one second processor, causes the display device to: receive the UPG from the computing system; and display the UPG on the display screen.

In some embodiments, the computing system might comprise one of a set-top box (“STB”), a digital video recording (“DVR”) device, a processor of the display device running a software application (“app”), a processor of a user device running an app, a server computer over a network, a cloud-based computing system over a network, a media player, or a gaming console, and/or the like.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### Specific Exemplary Embodiments

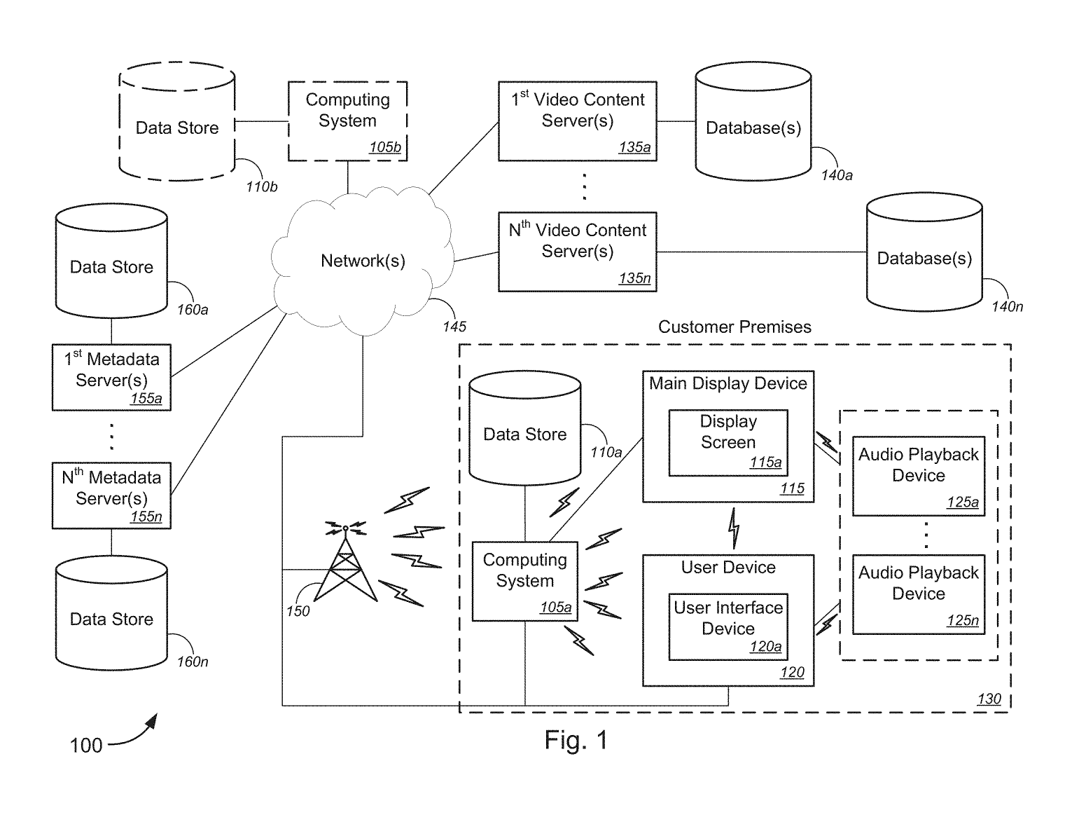

We now turn to the embodiments as illustrated by the drawings. FIGS. 1-6 illustrate some of the features of the method, system, and apparatus for implementing media content navigation and presentation, and, more particularly, to methods, systems, and apparatuses for implementing a unified multi-source video programming & navigation guide, as referred to above. The methods, systems, and apparatuses illustrated by FIGS. 1-6 refer to examples of different embodiments that include various components and steps, which can be considered alternatives or which can be used in conjunction with one another in the various embodiments. The description of the illustrated methods, systems, and apparatuses shown in FIGS. 1-6 is provided for purposes of illustration and should not be considered to limit the scope of the different embodiments.

With reference to the figures, FIG. 1 is a schematic diagram illustrating a system 100 for implementing a unified multi-source video programming & navigation guide (herein referred to simply as a unified program guide (“UPG”)), in accordance with various embodiments.

In the non-limiting embodiment of FIG. 1, system 100 might comprise a computing system 105a and a data store or database 110a that is local to the computing system 105a. In some cases, the data store 110a might be external, yet communicatively coupled, to the computing system 105a. In other cases, the data store 110a might be integrated within the computing system 105a. System 100, according to some embodiments, might further comprise one or more main display devices 115 (collectively, “main display devices 115” or “display devices 115,” or the like), which might each include a display screen 115a, and one or more user devices 120 (collectively, “user devices 120” or the like), which might each include a user interface device 120a (which in some cases might include, without limitation, a touchscreen display, a keypad, a keyboard, or other user interface devices, and/or the like), and/or the like. In some cases, system 100 might further, or optionally, comprise one or more audio playback devices 125a-125n (collectively, “audio playback devices 125” or “speakers 125,” or the like), and/or the like.

Each of the one or more main display devices 115 and/or the one or more user devices 120 might communicatively couple to the computing system 105a, and/or to each other, either via wireless connection and/or via wired connection. The one or more user devices 120 might each receive user input from a user (in various embodiments, by receiving touch input or other user input from the user via the user interface device 120a), and might each relay the user input to the computing system 105a, according to some embodiments. In some cases, the user devices 120 might include, without limitation, at least one of a dedicated remote control device (with touchscreen display and/or with button keypads, or the like) that is associated with the computing system 105a, a universal remote control device (with touchscreen display and/or with button keypads) that has been paired, synced, or synchronized with the computing system 105a, a tablet computer that has been paired, synced, or synchronized with the computing system 105a, a smart phone that has been paired, synced, or synchronized with the computing system 105a, or other portable device (with touchscreen display and/or with keypads or other user interface devices) that has been paired, synced, or synchronized with the computing system 105a, and/or the like. In some cases, the computing system 105a, the data store 110a, the one or more main display devices 115 (including the display screen(s) 115a and/or the audio playback device(s) 125, etc.), and the user device(s) 120 may be disposed within a customer premises 130, which might be one of a single family house, a multi-dwelling unit (“MDU”) within a multi-dwelling complex (including, but not limited to, an apartment building, an apartment complex, a condominium complex, a townhouse complex, a mixed-use building, etc.), a motel, an inn, a hotel, an office building or complex, a commercial building or complex, an industrial building or complex, and/or the like.

In some embodiments, the computing system 105a might comprise one of a processor on the main display device running a software application (“app”), a processor on the user device running an app, a media device, and/or the like. In some cases, the media device might include, but is not limited to, one of a set-top box (“STB”), a media player, a gaming console, a server computer, a desktop computer, or a laptop computer, and/or the like. The media player might include, without limitation, one of a digital versatile disc or digital video disc (“DVD”) player, a Blu-ray disc (“BD”) player, a digital video recording (“DVR”) device, a streaming video player, or a streaming game player, and/or the like, while the one or more main display devices 115 might include, but are not limited to, at least one of one or more monitors (e.g., computer monitor, laptop monitor, projection system, or the like), one or more television sets (e.g., smart television sets or other television sets, or the like), and/or the like. In some cases, the user device 120 might include, without limitation, one of a laptop computer, a tablet computer, a smart phone, a mobile phone, a personal digital assistant, a remote control device, or a portable gaming device, and/or the like.

System 100 might further comprise one or more first video content sources or servers 135a through one or more N^{th} video content sources or servers 135n (collectively, “video content sources 135,” “video content servers 135,” or the like) and corresponding databases 140a-140n (collectively, “databases 140” or the like) that might communicatively couple to the computing system 105a via one or more networks 145 (and in some cases, via one or more telecommunications relay systems 150, which might include, without limitation, one or more wireless network interfaces (e.g., wireless modems, wireless access points, and the like), one or more towers, one or more satellites, and/or the like). The lightning bolt symbols are used to denote wireless communications between the one or more telecommunications relay systems 150 and the computing system 105a, between the one or more telecommunications relay systems 150 and each of at least one of the user devices 120, between the computing system 105a and each of at least one of the main display devices 115, between the computing system 105a and each of at least one of the user devices 120, between the main display device 115 and the user devices 120, between the computing system 105a and each of the one or more audio playback devices 125a-125n, between the main display device 115 and each of at least one of the one or more audio playback devices 125a-125n, between the user devices 120 and each of at least one of the one or more audio playback devices 125a-125n, and/or the like.

According to some embodiments, alternative or additional to the computing system 105a and corresponding data store 110a being disposed within customer premises 130, system 100 might comprise remote computing system 105b and corresponding data store(s) 110b that communicatively couple with the one or more main display devices 115 and/or with the one or more user devices 120 in the customer premises 130 via the one or more networks 145 (and in some cases, via the one or more telecommunications relay systems 150). According to some embodiments, remote computing system 105b might comprise at least one of a server computer over a network, a cloud-based computing system over a network, and/or the like.

In some embodiments, system 100 might further comprise one or more first metadata sources or servers 155a through one or more N^{th} metadata sources or servers 155n (collectively, “metadata sources 155,” “metadata servers 155,” or the like) and corresponding data stores 160a-160n (collectively, “data stores 160” or the like) that might communicatively couple to the computing system 105a via the one or more networks 145 (and in some cases, via one or more telecommunications relay systems 150). The metadata sources 155 and corresponding data stores 160 might provide the computing system 105a or 105b with access to metadata corresponding to video content that is available from the video content sources 135 and corresponding databases 140. In some cases, the plurality of video content sources 135 might include, but is not limited to, at least two of one or more video streaming sources, one or more video broadcast sources, one or more off the air (“OTA”) sources, one or more satellite television (“TV”) sources, one or more cable TV sources, or one or more third party video content sources, and/or the like.

In operation, the computing system 105a or 105b (collectively, “computing system 105,” or the like, which in some cases may be embodied by a set-top box (“STB”) or the like) might receive one or more first metadata (e.g., from one or more of the metadata sources 155a-155n and corresponding data stores 160a-160n), the one or more first metadata corresponding to one or more first video content available from a first video content source 135a among a plurality of video content sources 135a-135n (and corresponding databases 140a among the plurality of databases 140a-140n). The computing system 105 might also receive one or more second metadata (e.g., from one or more others of the metadata sources 155a-155n and corresponding data stores 160a-160n), the one or more second metadata corresponding to one or more second video content available from a second video content source 135b among the plurality of video content sources 135a-135b (and corresponding databases 140b among the plurality of databases 140a-140n). The second video content source might be of a different type from that of the first video content source—that is, one of the first and second video content sources might be one of a video streaming source, a video broadcast source, an off the air (“OTA”) source, a satellite television (“TV”) source, a cable TV source, or a third party video content source, and/or the like, while the other of the first and second video content sources might be another of the video streaming source, the video broadcast source, the OTA source, the satellite TV source, the cable TV source, or the third party video content source, and/or the like.

In some embodiments, the metadata might be pulled from the corresponding metadata source(s) 155 and/or corresponding data 160 by the computing system 105, using a pull data function or the like (or according to a pull data distribution model or the like). Alternatively, the metadata source(s) 155 might broadcast or push the metadata to the computing system 105 (or a plurality of similar computing systems across a plurality of customer premises), using a push data function or the like (or according to a push data distribution model or the like).

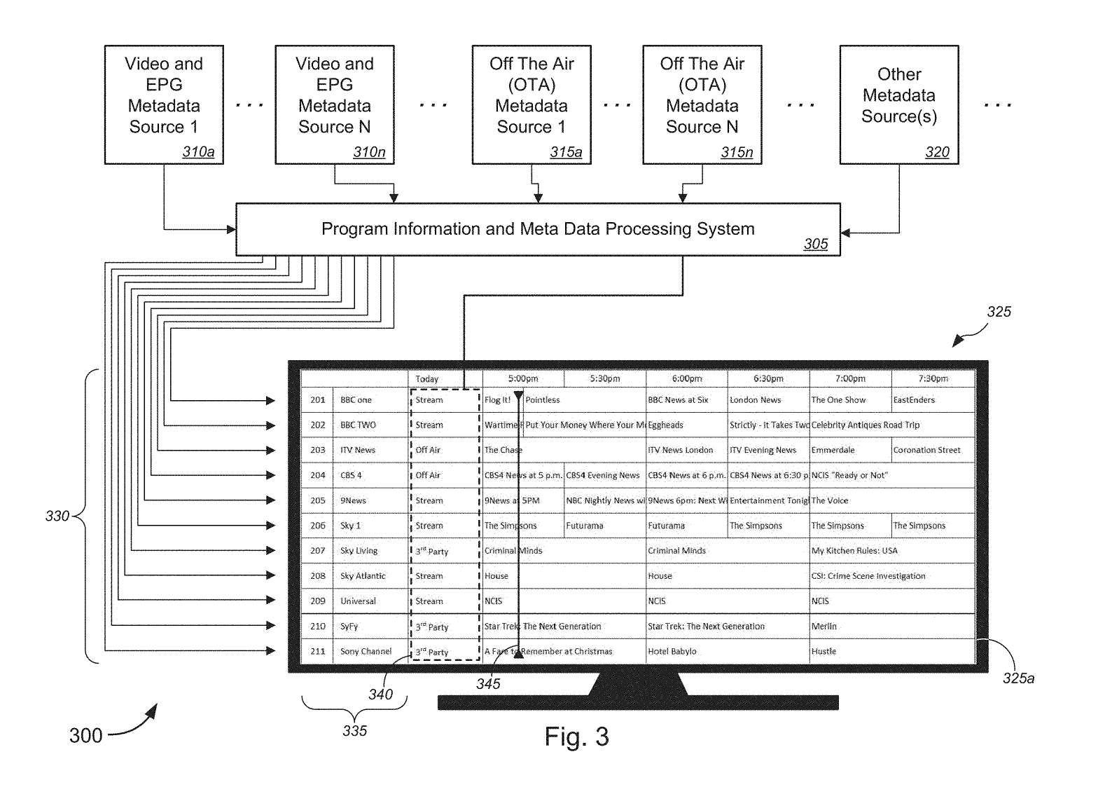

The computing system 105 might also compile the one or more first metadata and the one or more second metadata and generate a unified multi-source video programming and navigation guide (“UPG”) that lists in a blended fashion the one or more first video content and the one or more second video content, based at least in part on the one or more first metadata and the one or more second metadata, the UPG presenting the blended listing of the one or more first video content and the one or more second video content in a grid with at least one of channel, video content source, or video content along a first axis of the grid and with start times along a second axis of the grid (as shown, e.g., in the non-limiting example of FIG. 3, or the like). The computing system 105 might further display the UPG on a display screen 115a of the display device 115.

According to some embodiments, the UPG may be updated or refreshed in response to a trigger. In some instances, the trigger might include, without limitation, one of power-up of the computing system, boot-up of the computing system, wake-up of the computing system, periodic update timer, or user request operator instruction, and/or the like. In some embodiments, the computing system 105 might receive first user input from a user, the first user input causing the UPG being displayed on the display device in a particular order or grouping; might update the UPG in accordance with the particular order or grouping; and might display the updated UPG on the display device. Merely by way of example, in some cases, the particular order or grouping might be based on one of channel numbers, station names, genre groupings, favorites groupings, or a combination of one or more of channel numbers, station names, genre groupings, or favorites groupings, and/or the like.

In some embodiments, the computing system 105 might receive second user input from a user, the second user input comprises a selection of a video content from among the blended listing of the one or more first video content and the one or more second video content of the UPG; might, in response to receiving the second user input, determine which video content source of the one or more first video content sources or the one or more second video content sources corresponds to the selected video content in accordance with the second user input; might, based on the determined video content source, access the selected video content from the determined video content source; and might display the selected video content on the display device. In some cases, receiving second user input from the user might comprise receiving the second user input from the user via the one or more user devices 120.

The system described herein is able to access content metadata from multiple sources and to process them. It uses the processed metadata to populate an enhanced EPG or UPG, blending all available content into a single, coherent content access and navigation system (as depicted, e.g., in FIG. 3, or the like). Sources might include, but are not limited to, one or several video and EPG metadata sources (which might be specified by the operator or provider, or the like), one or several OTA metadata sources (which might be operator and/or provider-specified as well as user-specified, or the like), one or several satellite TV metadata sources (which might be specified by the operator or provider, or the like), one or several cable TV metadata sources (which might be specified by the operator or provider, or the like), one or several third party metadata sources (which might be operator and/or provider-specified as well as user-specified, or the like), one or several partner provider metadata sources (which might be specified by the operator or provider, or the like), and/or the like.

Once the program information and metadata have been retrieved, they are processed and checked for inconsistencies to handle cases of potentially conflicting information. In some cases, the consistency mechanism might be needed to recognize and resolve potential inconsistencies among metadata from different providers, which is described in detail in the '982 application, which has already been incorporated herein by reference in its entirety for all purposes.

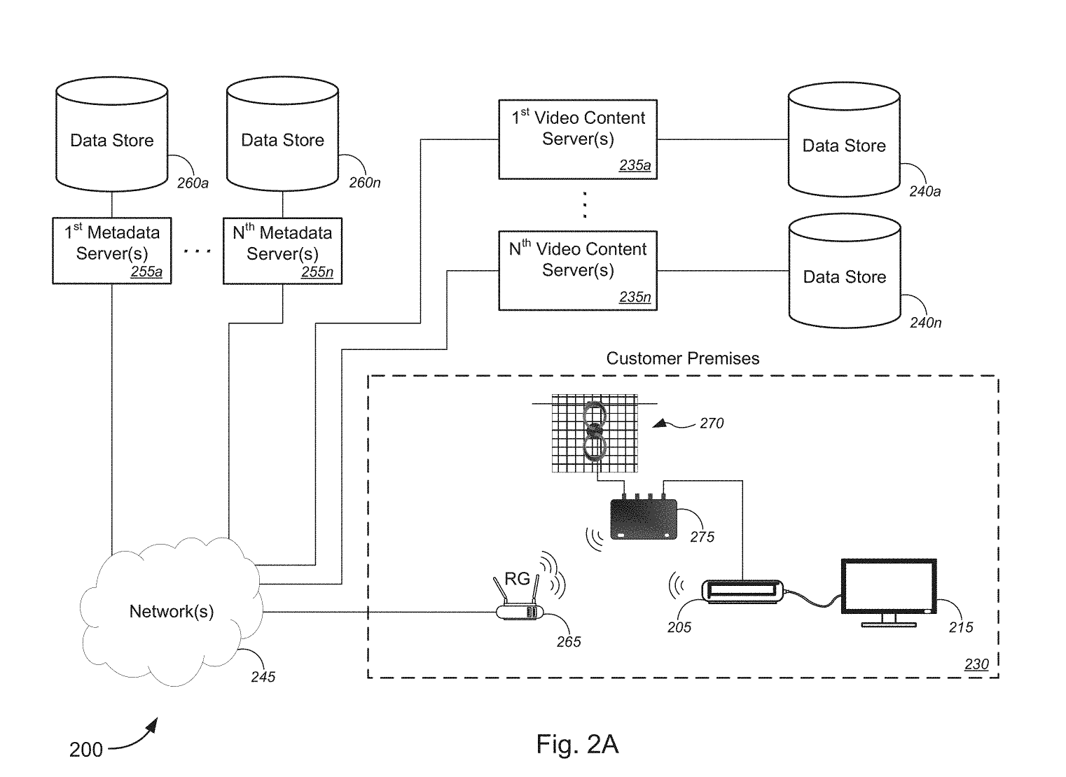

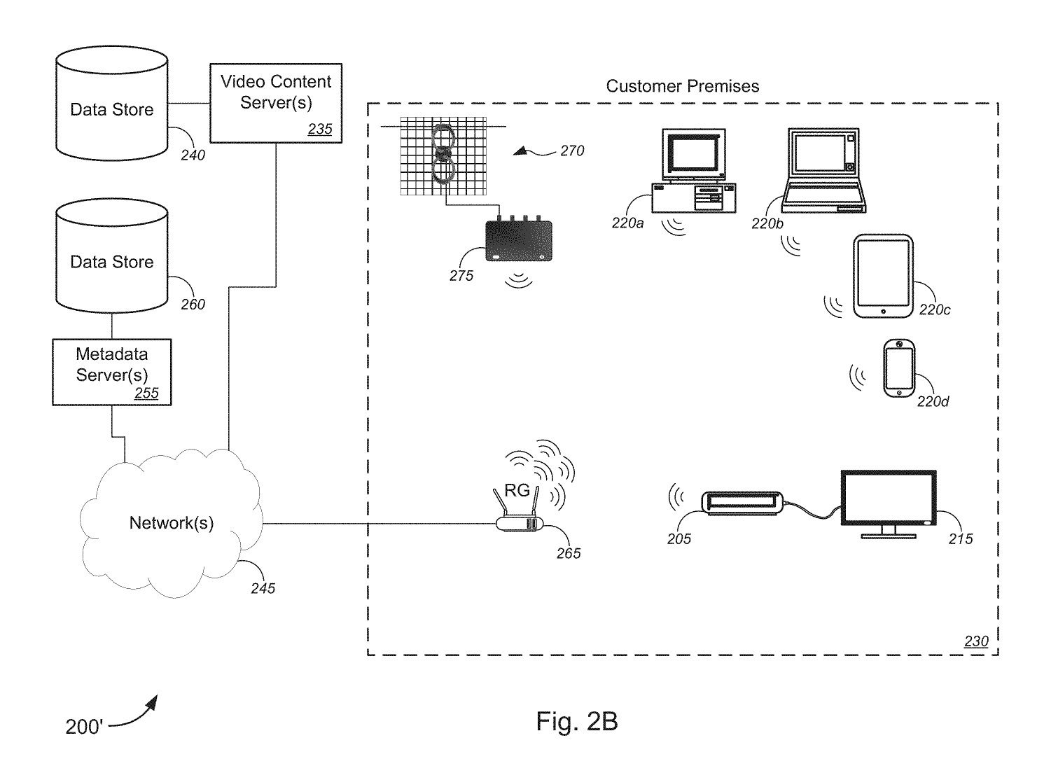

These and other functions of the system 100 (and its components) are described in greater detail below with respect to FIGS. 2-4.

FIGS. 2A and 2B (collectively, “FIG. 2”) are schematic diagrams illustrating various systems 200 and 200′ for implementing a unified multi-source video programming & navigation guide, in accordance with various embodiments.

In the non-limiting embodiment of FIG. 2A, system 200 might comprise a set-top box (“STB”) 205, a display device 215 (including, without limitation, one of a television set, a smart television, a computer monitor, a laptop monitor, or a projection system, and/or the like), a residential gateway (“RG”) 265, and an antenna 270, all of which might be disposed at customer premises 230. In some cases, the antenna 270 might include, but is not limited to, a passive antenna intended to be connected to the STB's antenna input (which, in North America, is typically an F-connector, or the like), a passive antenna with amplifier to boost the signal (which might also be intended to be connected to a STB's antenna input), or an antenna with an amplifier, demodulating circuitry, and network interfaces, intended for distribution of the OTA signal throughout a building via a wired or wireless network (this enables devices without a tuner to receive OTA signals, or the like), and/or the like.

System 200 might further comprise one or more first video content sources or servers 235a through one or more N^{th} video content sources or servers 235n (collectively, “video content sources 235,” “video content servers 235,” or the like) and corresponding databases 240a-240n (collectively, “databases 240” or the like) that might communicatively couple to the RG 265 via one or more networks 245. The wave symbols are used to denote wireless communications between the RG 265 and the STB 205, and/or the like. In some embodiments, system 200 might further comprise one or more first metadata sources or servers 255a through one or more N^{th} metadata sources or servers 255n (collectively, “metadata sources 255,” “metadata servers 255,” or the like) and corresponding data stores 260a-260n (collectively, “data stores 260” or the like) that might communicatively couple to the RG 265 via the one or more networks 245. The metadata sources 255 and corresponding data stores 260 provide the STB 205 with access to metadata corresponding to video content that is available from the video content sources 235 and corresponding databases 240. In some cases, the plurality of video content sources 235 might include, but is not limited to, at least two of one or more video streaming sources, one or more video broadcast sources, one or more off the air (“OTA”) sources, one or more satellite television (“TV”) sources, one or more cable TV sources, or one or more third party video content sources, and/or the like.

According to some embodiments, the user might select an input source (e.g., network connection or antenna input, or the like) to access content available from the operator or OTA content. Furthermore, the user might need to consult separate listings of operator-provided content versus streaming video, TV OTA, satellite TV, and/or cable TV programming to view available content.

The STB 205, the display device 215, the one or more video content sources 235a-235n, the data store 240a-240n, the network(s) 245, the one or more metadata sources 255a-255n, and the data store 260a-260n of system 200 in FIG. 2A might otherwise be similar, if not identical, to the computing system 105, the display device 115, the one or more video content sources 135a-135n, the data store 140a-140n, the network(s) 145, the one or more metadata sources 155a-155n, and the data store 160a-160n, respectively, of system 100 in FIG. 1, and the descriptions of these components of system 100 are applicable to the corresponding components of system 200, respectively.

With reference to FIG. 2B, system 200′ might comprise a STB 205, a display device 215 (including, without limitation, one of a television set, a smart television, a computer monitor, a laptop monitor, or a projection system, and/or the like), one or more user devices 220a-220d (collectively, “user devices 220,” or the like), a RG 265, an antenna 270, and an OTA, satellite, or cable TV receiver 275, all of which might be disposed at customer premises 230. In some cases, the antenna 270 might include, but is not limited to, a passive antenna intended to be connected to the STB's antenna input (which, in North America, is typically an F-connector, or the like), a passive antenna with amplifier to boost the signal (which might also be intended to be connected to a STB's antenna input), or an antenna with an amplifier, demodulating circuitry, and network interfaces, intended for distribution of the OTA signal throughout a building via a wired or wireless network (this enables devices without a tuner to receive OTA signals, or the like), and/or the like. In the non-limiting example of FIG. 2B, the OTA, satellite, or cable TV receiver 275 might receive OTA signals picked up by the antenna 270, might amplify and demodulate the received OTA signals, and/or might enable all devices (i.e., the STB 205, the display device 215, the user devices 220, or the like) on the home network (whether wireless or wired) to access the OTA video stream and be capable of displaying it via a suitable video player (e.g., hardware and/or software).

System 200 might further comprise one or more video content sources or servers 235 and corresponding databases 240 that might communicatively couple to the RG 265 via one or more networks 245. The wave symbols are used to denote wireless communications between the RG 265 and each of the STB 205, one or more of the user devices 220a-220d, and/or the OTA, satellite, or cable TV receiver 275, and/or the like. In some embodiments, system 200 might further comprise one or more metadata sources or servers 255 and corresponding data stores 260 that might communicatively couple to the RG 265 via the one or more networks 245. The metadata sources 255 and corresponding data stores 260 provide the STB 205 with access to metadata corresponding to video content that is available from the video content sources 235 and corresponding databases 240. In some cases, the plurality of video content sources 235 might include, but is not limited to, at least two of one or more video streaming sources, one or more video broadcast sources, one or more off the air (“OTA”) sources, one or more satellite television (“TV”) sources, one or more cable TV sources, or one or more third party video content sources, and/or the like.

The STB 205, the display device 215, the one or more user devices 220a-220d, the one or more video content sources 235, the data store 240, the network(s) 245, the one or more metadata sources 255, and the data store 260 of system 200′ in FIG. 2B might otherwise be similar, if not identical, to the computing system 105, the display device 115, the one or more user devices 120, the one or more video content sources 135a-135n, the data store 140a-140n, the network(s) 145, the one or more metadata sources 155a-155n, and the data store 160a-160n, respectively, of system 100 in FIG. 1, and the descriptions of these components of system 100 are applicable to the corresponding components of system 200′.

In some embodiments, in the scenarios as depicted in FIGS. 2A and 2B, users generally need to select an input source on the STB 205 and might refer to separate listings or program guides to view operator content as well as OTA content. Operator-sourced content and metadata might typically be made available via an electronic programming guide (“EPG”) or a unified multi-source video programming and navigation guide (“UPG”), or the like.

FIG. 3 is a schematic diagram illustrating a system 300 for implementing a unified multi-source video programming & navigation guide, in accordance with various embodiments.

In the non-limiting embodiment of FIG. 3, system 300 might comprise program information and metadata processing system 305, one or more video and EPG metadata sources 1 through N 310a-310n (collectively, “video and EPG metadata sources 310,” “metadata sources 310,” or the like), one or more over the air or off the air (“OTA”) metadata source 1 through N 315a-315n (collectively, “OTA metadata sources 315,” “metadata sources 315,” or the like), one or more other metadata sources 320, and/or the like. In some cases, the one or more other metadata sources 320 might include, without limitation, one or more video streaming sources, one or more video broadcast sources, one or more satellite television (“TV”) sources, one or more cable TV sources, one or more third party metadata sources, one or more partner provider metadata sources, and/or the like.

Program information and metadata processing system 305 might compile metadata from each of the different metadata sources 310, 315, and 320. System 300 might further comprise display device 325, which might comprise a display screen 325a. The system (i.e., a set-top box or other computing system, such as STB or computing system 105a, 105b, 205, and/or 275 of FIGS. 1, 2A, and 2B, or the like) might generate a unified multi-source video programming and navigation guide (“UPG”) 330 that lists in a blended fashion one or more first video content, one or more second video content, and/or one or more third video content, based at least in part on the one or more first metadata, the one or more second metadata, and/or the one or more third metadata from respective metadata sources 310, 315, and 320. The system (i.e., a set-top box or other computing system, such as STB or computing system 105a, 105b, 205, and/or 275 of FIGS. 1, 2A, and 2B, or the like) might display the UPG 330 on the display screen 325a of the display device 325. The UPG 330 might present the blended listing of the one or more first video content, the one or more second video content, and the one or more third video content, in a grid with at least one of channel 335, video content source 335, or video content along a first axis of the grid and with start times along a second axis of the grid—as depicted by dashed line box 340. In FIG. 3, the line 345 (with inward-pointing arrows) indicates the running or current time (which is optionally displayed to the user).

Once the program information and metadata have been retrieved, they are processed and checked for inconsistencies to handle cases of potentially conflicting information. In some cases, the consistency mechanism might be needed to recognize and resolve potential inconsistencies among metadata from different providers, which is described in detail in the '982 application, which has already been incorporated herein by reference in its entirety for all purposes. The processed and formatted programming in formation and metadata may be used to populate a unified EPG or a UPG, as shown, e.g., in FIG. 3. Programming information can be displayed according to any desired criteria, including, but not limited to, channel numbers, station names, genre, favorites, or a combination of these criteria, and/or the like.

Optionally, the origin of program material may be displayed, as shown in FIG. 3. This feature may be enabled or disabled by the operator and/or by the end user. Examples of origin information might include, without limitation, “stream” (indicating content streaming to the STB via a network connection), “off air” or “over the air” or “antenna” (indicating OTA signal received via the antenna), “satellite” (indicating satellite TV signal received via a receiver), “cable” (indicating cable TV signal received by the STB), “3^{rd} party” (indicating content accessed by the STB in other ways), and/or the like. According to some embodiments, users might be able to navigate the UPG 330 in both x and y directions. The x-axis might be used to move forward or backward in time, while the y-axis might be used to move among channels or other content sources. Users can move among channel or other input sources in a seamless way, disregarding the nature of the content source (e.g., network stream, OTA, or the like), and/or the like.

In addition to linear live content, the program guide can include locally stored on-demand content or remotely hosted on-demand content, or both. The UPG data can either be requested from the STB (in a “pull” data distribution model) or offered from the external metadata sources (in a “push” data distribution model). The updates and/or refreshes can be triggered based on a number of different events. The trigger might include, without limitation, one of power-up of the computing system, boot-up of the computing system, wake-up of the computing system, periodic update timer, user request operator instruction, or some other event internal or external to the STB, and/or the like.

In some embodiments, OTA devices can contain more than one HDTV tuner or the like. In some cases, very compact devices with as many as four HDTV OTA tuners are readily available. There is no principal reason why the number of tuners cannot be significantly expanded in the future. In some embodiments, the tuner functionality can be expanded to include the ability to receive, demodulate, and decode satellite video signals (“satellite TV signals”). Alternatively, or additionally, the tuner functionality can be expanded to include the ability to receive, demodulate, and decode cable video signals (“cable TV signals”).

According to some embodiments, available content might vary, dependent on the user's location (or location of the customer premises), due to content blackout restrictions, locally available programming and content plan chosen by the subscriber. The program information and metadata processing system 305 can take advantage of location information, if available. For example, STBs could be shipped preconfigured with the required location information to properly handle blackout restrictions and local programming. This data could also be derived based on other operator-provided information or information potentially available to the STB (e.g., subscriber phone number or the like). Alternatively, users can enter their address or zip code information or other customer information identifying their location. Advanced systems can also use methods of geolocation such as global positioning system (“GPS”) or comparable system to obtain location information, or the like. The software and/or hardware implementing the system described herein can reside on either the main STB or on the OTA receiver. Alternatively, parts of this unified EPG or UPG, or navigation system could be residing on both the OTA receiver as well as the main STB, and the like.

The program information and metadata processing system 305, the display device 325, the one or more metadata sources 310a-310n, 315a-315n, and 320 of system 300 in FIG. 3 might otherwise be similar, if not identical, to the computing system 105, the display device 115, the one or more metadata sources 155a-155n, respectively, of system 100 in FIG. 1, and the descriptions of these components of system 100 are applicable to the corresponding components of system 300.

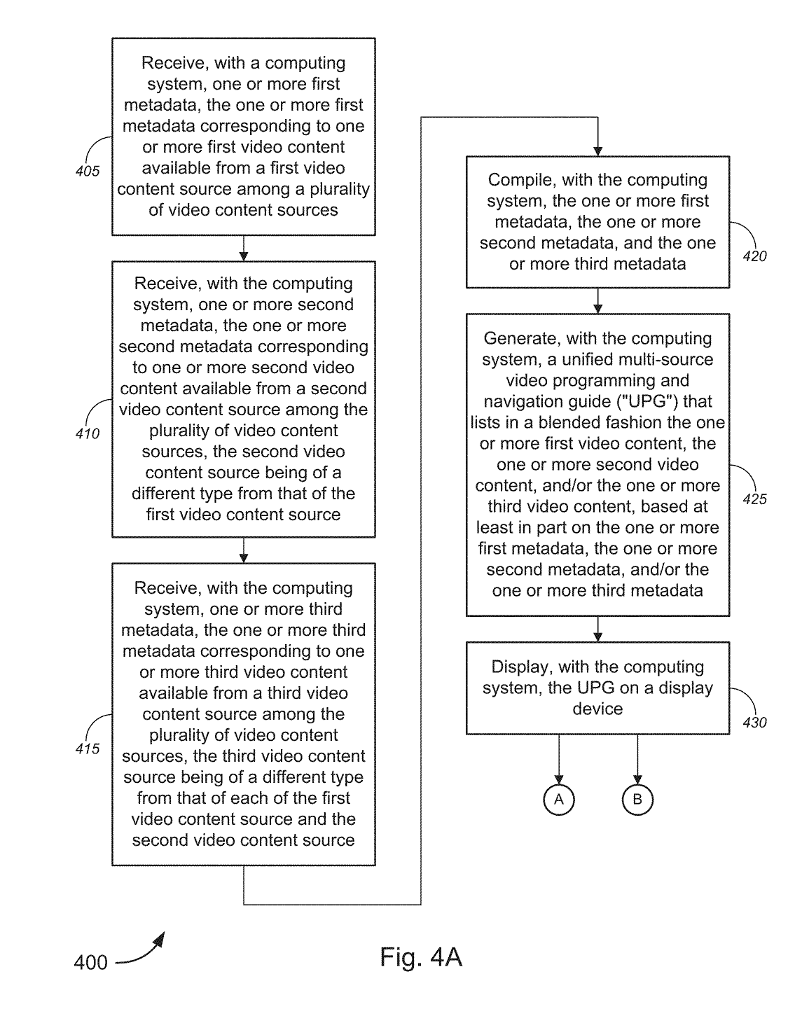

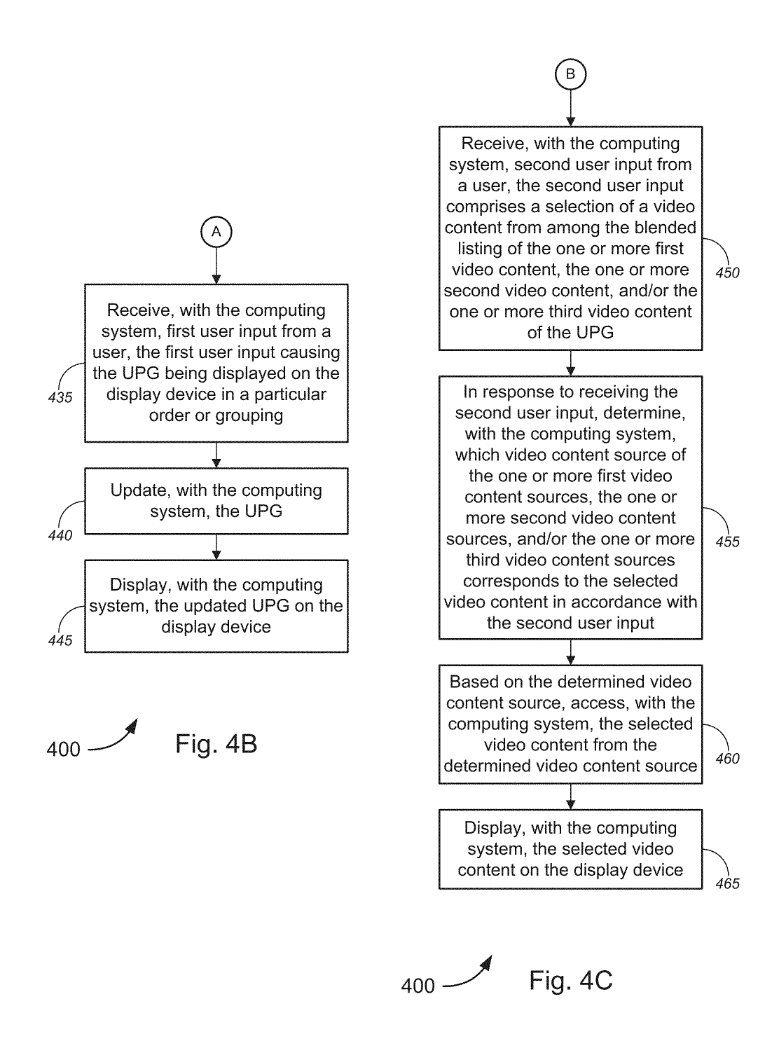

FIGS. 4A-4C (collectively, “FIG. 4”) are flow diagrams illustrating a method 400 for implementing a unified multi-source video programming & navigation guide, in accordance with various embodiments. Method 400 of FIG. 4A continues onto FIG. 4B following the circular marker denoted, “A,” and continues from FIG. 4A onto FIG. 4C following the circular marker denoted, “B.”

While the techniques and procedures are depicted and/or described in a certain order for purposes of illustration, it should be appreciated that certain procedures may be reordered and/or omitted within the scope of various embodiments. Moreover, while the method 400 illustrated by FIG. 4 can be implemented by or with (and, in some cases, are described below with respect to) the systems 100, 200, 200′, and 300 of FIGS. 1, 2A, 2B, and 3, respectively (or components thereof), such methods may also be implemented using any suitable hardware (or software) implementation. Similarly, while each of the systems 100, 200, 200′, and 300 of FIGS. 1, 2A, 2B, and 3, respectively (or components thereof), can operate according to the method 400 illustrated by FIG. 4 (e.g., by executing instructions embodied on a computer readable medium), the systems 100, 200, 200′, and 300 of FIGS. 1, 2A, 2B, and 3 can each also operate according to other modes of operation and/or perform other suitable procedures.

In the non-limiting embodiment of FIG. 4A, method 400 might comprise receiving, with a computing system, one or more first metadata, the one or more first metadata corresponding to one or more first video content available from a first video content source among a plurality of video content sources (block 405); receiving, with the computing system, one or more second metadata, the one or more second metadata corresponding to one or more second video content available from a second video content source among the plurality of video content sources, the second video content source being of a different type from that of the first video content source (block 410); and receiving, with the computing system, one or more third metadata, the one or more third metadata corresponding to one or more third video content available from a third video content source among the plurality of video content sources, the third video content source being of a different type from that of each of the first video content source and the second video content source (block 415).

In some embodiments, the computing system might include, without limitation, one of a set-top box (“STB”), a digital video recording (“DVR”) device, a processor of the display device running a software application (“app”), a processor of a user device running an app, a server computer over a network, a cloud-based computing system over a network, a media player, or a gaming console, and/or the like. In some cases, the plurality of video content sources might include, but is not limited to, at least two of one or more video streaming sources, one or more video broadcast sources, one or more off the air (“OTA”) sources, one or more satellite television (“TV”) sources, one or more cable TV sources, or one or more third party video content sources, and/or the like. In some instances, each of the one or more first metadata, the one or more second metadata, and the one or more third metadata is received by the computing system in response to one of a pull data distribution instruction or a push data distribution instruction.

At block 420, method 400 might comprise compiling, with the computing system, the one or more first metadata, the one or more second metadata, and the one or more third metadata. Method 400 might further comprise, at block 425, generating, with the computing system, a unified multi-source video programming and navigation guide (“UPG”) that lists in a blended fashion the one or more first video content, the one or more second video content, and/or the one or more third video content, based at least in part on the one or more first metadata, the one or more second metadata, and/or the one or more third metadata, the UPG presenting the blended listing of the one or more first video content, the one or more second video content, and/or the one or more third video content, in a grid with at least one of channel, video content source, or video content along a first axis of the grid and with start times along a second axis of the grid (as shown, e.g., in the non-limiting embodiment of FIG. 3). Method 400 might further comprise displaying, with the computing system, the UPG on a display device (i.e., a display screen of the display device, or the like) (block 430). In some instances, the display device might include, without limitation, one of a television set, a smart television, a computer monitor, a laptop monitor, or a projection system, and/or the like. Method 400 might continue onto the process at block 435 of FIG. 4B following circular marker denoted, “A,” and/or might continue onto the process at block 450 of FIG. 4C following circular marker denoted, “B.”

With reference to FIG. 4B (following circular marker “A” from FIG. 4A), method 400 might further comprise receiving, with the computing system, first user input from a user, the first user input causing the UPG being displayed on the display device in a particular order or grouping (block 435); updating, with the computing system, the UPG in accordance with the particular order or grouping (block 440); and displaying, with the computing system, the updated UPG on the display device (block 445). According to some embodiments, the particular order or grouping might be based on one of channel numbers, station names, genre groupings, favorites groupings, or a combination of one or more of channel numbers, station names, genre groupings, or favorites groupings, and/or the like.

In alternative (or additional) embodiments, the UPG might be updated or refreshed in response to a trigger, the trigger including, but not limited to, one of power-up of the computing system, boot-up of the computing system, wake-up of the computing system, periodic update timer, or user request operator instruction, and/or the like.

Turning to FIG. 4C (following circular marker “B” from FIG. 4B), method 400 might further comprise, at block 450, receiving, with the computing system, second user input from the user, the second user input including, without limitation, a selection of a video content from among the blended listing of the one or more first video content, the one or more second video content, and/or the one or more third video content of the UPG. In some embodiments, receiving second user input from the user might comprise receiving, with the computing system, the second user input from the user via one or more user devices. The one or more user devices might each include, but is not limited to, one of a laptop computer, a tablet computer, a smart phone, a mobile phone, a personal digital assistant, a remote control device, or a portable gaming device, and/or the like. At block 455, method 400 might comprise, in response to receiving the second user input, determining, with the computing system, which video content source of the one or more first video content sources, the one or more second video content sources, and/or the one or more third video content sources corresponds to the selected video content in accordance with the second user input.

Method 400 might further comprise, based on the determined video content source, accessing, with the computing system, the selected video content from the determined video content source (block 460) and displaying, with the computing system, the selected video content on the display device (block 465).

Exemplary System and Hardware Implementation

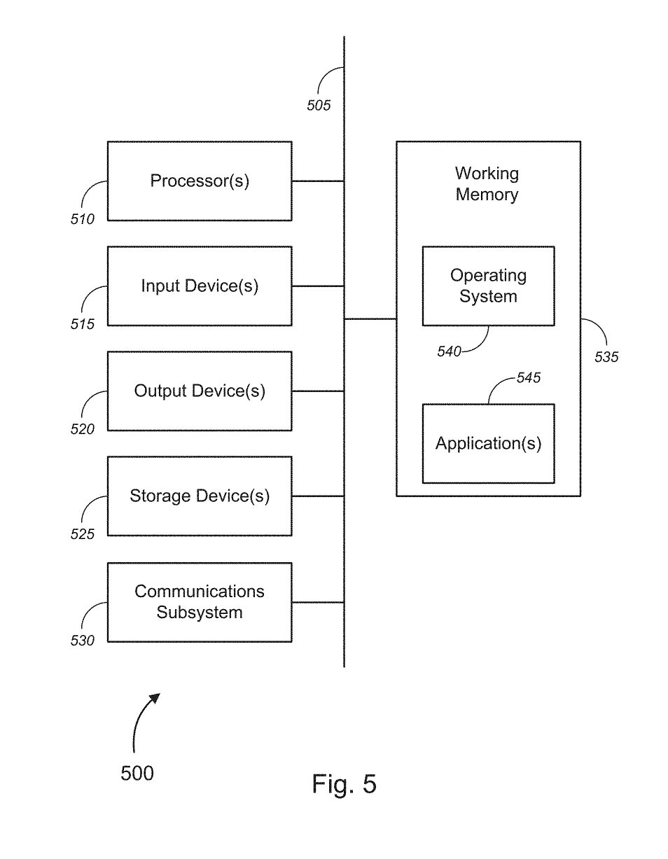

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., computing systems 105a and 105b, (main) display devices 115, 215, and 325, user devices 120 and 220a-220d, audio playback devices 125a-125n, video content sources (or servers) 135a-135n, 235a-235n, and 235, metadata sources (or servers) 155a-155n, 255a-255n, 255, 310a-310n, 315a-315n, and 320, residential gateway 265, off the air (“OTA”), satellite, or cable TV gateway device 275, program information and meta data processing system 305, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500—which might represent an embodiment of the computer or hardware system (i.e., computing systems 105a and 105b, (main) display devices 115, 215, and 325, user devices 120 and 220a-220d, audio playback devices 125a-125n, video content sources (or servers) 135a-135n, 235a-235n, and 235, metadata sources (or servers) 155a-155n, 255a-255n, 255, 310a-310n, 315a-315n, and 320, residential gateway 265, OTA, satellite, or cable TV gateway device 275, program information and meta data processing system 305, etc.), described above with respect to FIGS. 1-4—is shown comprising hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard and/or the like; and one or more output devices 520, which can include, without limitation, a display device, a printer, and/or the like.

The computer or hardware system 500 may further include (and/or be in communication with) one or more storage devices 525, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further comprise a working memory 535, which can include a RAM or ROM device, as described above.

The computer or hardware system 500 also may comprise software elements, shown as being currently located within the working memory 535, including an operating system 540, device drivers, executable libraries, and/or other code, such as one or more application programs 545, which may comprise computer programs provided by various embodiments (including, without limitation, hypervisors, VMs, and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire and fiber optics, including the wires that comprise the bus 505, as well as the various components of the communication subsystem 530 (and/or the media by which the communications subsystem 530 provides communication with other devices). In an alternative set of embodiments, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

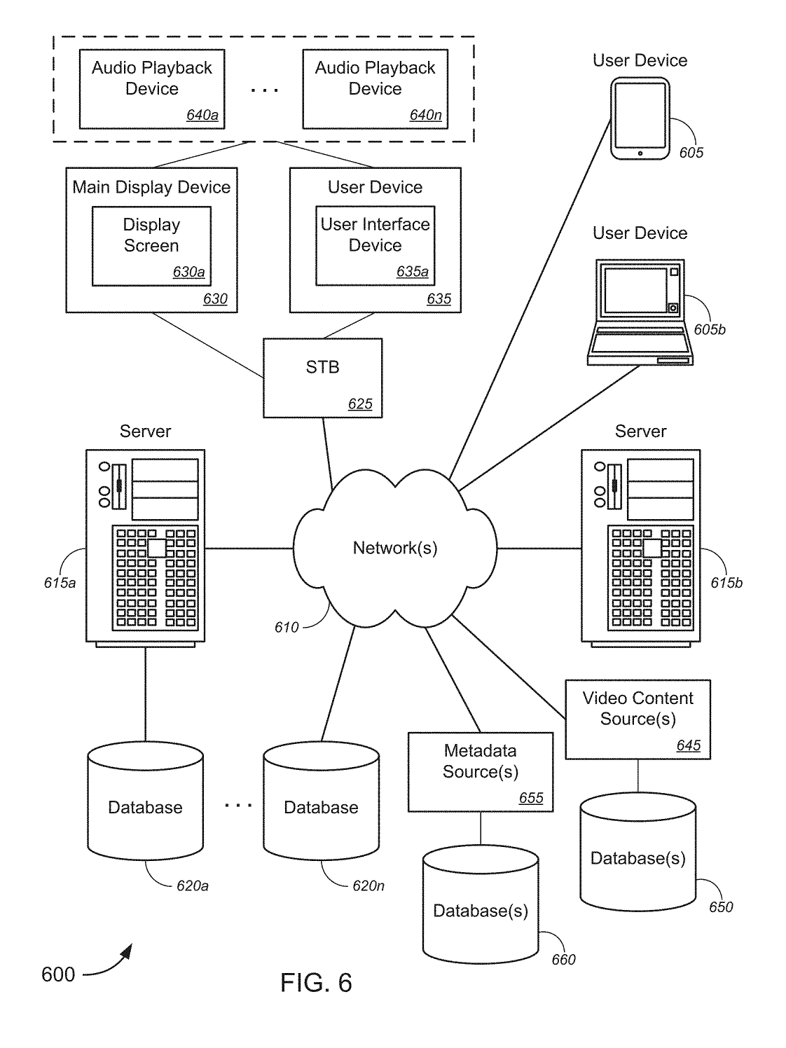

As noted above, a set of embodiments comprises methods and systems for implementing media content navigation and presentation, and, more particularly, to methods, systems, and apparatuses for implementing a unified multi-source video programming & navigation guide. FIG. 6 illustrates a schematic diagram of a system 600 that can be used in accordance with one set of embodiments. The system 600 can include one or more user computers, user devices, or customer devices 605. A user computer, user device, or customer device 605 can be a general purpose personal computer (including, merely by way of example, desktop computers, tablet computers, laptop computers, handheld computers, and the like, running any appropriate operating system, several of which are available from vendors such as Apple, Microsoft Corp., and the like), cloud computing devices, a server(s), and/or a workstation computer(s) running any of a variety of commercially-available UNIX™ or UNIX-like operating systems. A user computer, user device, or customer device 605 can also have any of a variety of applications, including one or more applications configured to perform methods provided by various embodiments (as described above, for example), as well as one or more office applications, database client and/or server applications, and/or web browser applications. Alternatively, a user computer, user device, or customer device 605 can be any other electronic device, such as a thin-client computer, Internet-enabled mobile telephone, and/or personal digital assistant, capable of communicating via a network (e.g., the network(s) 610 described below) and/or of displaying and navigating web pages or other types of electronic documents. Although the exemplary system 600 is shown with two user computers, user devices, or customer devices 605, any number of user computers, user devices, or customer devices can be supported.

Certain embodiments operate in a networked environment, which can include a network(s) 610. The network(s) 610 can be any type of network familiar to those skilled in the art that can support data communications using any of a variety of commercially-available (and/or free or proprietary) protocols, including, without limitation, TCP/IP, SNA™, IPX™, AppleTalk™, and the like. Merely by way of example, the network(s) 610 (similar to networks 145 and 245 of FIGS. 1 and 2, or the like) can each include a local area network (“LAN”), including, without limitation, a fiber network, an Ethernet network, a Token-Ring™ network and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network might include an access network of the service provider (e.g., an Internet service provider (“ISP”)). In another embodiment, the network might include a core network of the service provider, and/or the Internet.

Embodiments can also include one or more server computers 615. Each of the server computers 615 may be configured with an operating system, including, without limitation, any of those discussed above, as well as any commercially (or freely) available server operating systems. Each of the servers 615 may also be running one or more applications, which can be configured to provide services to one or more clients 605 and/or other servers 615.

Merely by way of example, one of the servers 615 might be a data server, a web server, a cloud computing device(s), or the like, as described above. The data server might include (or be in communication with) a web server, which can be used, merely by way of example, to process requests for web pages or other electronic documents from user computers 605. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 605 to perform methods of the invention.

The server computers 615, in some embodiments, might include one or more application servers, which can be configured with one or more applications accessible by a client running on one or more of the client computers 605 and/or other servers 615. Merely by way of example, the server(s) 615 can be one or more general purpose computers capable of executing programs or scripts in response to the user computers 605 and/or other servers 615, including, without limitation, web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including, without limitation, those commercially available from Oracle™, Microsoft™, Sybase™, IBM™, and the like, which can process requests from clients (including, depending on the configuration, dedicated database clients, API clients, web browsers, etc.) running on a user computer, user device, or customer device 605 and/or another server 615. In some embodiments, an application server can perform one or more of the processes for implementing media content navigation and presentation, and, more particularly, to methods, systems, and apparatuses for implementing a unified multi-source video programming & navigation guide, as described in detail above. Data provided by an application server may be formatted as one or more web pages (comprising HTML, JavaScript, etc., for example) and/or may be forwarded to a user computer 605 via a web server (as described above, for example). Similarly, a web server might receive web page requests and/or input data from a user computer 605 and/or forward the web page requests and/or input data to an application server. In some cases, a web server may be integrated with an application server.

In accordance with further embodiments, one or more servers 615 can function as a file server and/or can include one or more of the files (e.g., application code, data files, etc.) necessary to implement various disclosed methods, incorporated by an application running on a user computer 605 and/or another server 615. Alternatively, as those skilled in the art will appreciate, a file server can include all necessary files, allowing such an application to be invoked remotely by a user computer, user device, or customer device 605 and/or server 615.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 620a-620n (collectively, “databases 620”). The location of each of the databases 620 is discretionary: merely by way of example, a database 620a might reside on a storage medium local to (and/or resident in) a server 615a (and/or a user computer, user device, or customer device 605). Alternatively, a database 620n can be remote from any or all of the computers 605 and 615, so long as it can be in communication (e.g., via the network 610) with one or more of these. In a particular set of embodiments, a database 620 can reside in a storage-area network (“SAN”) familiar to those skilled in the art. (Likewise, any necessary files for performing the functions attributed to the computers 605 and 615 can be stored locally on the respective computer and/or remotely, as appropriate.) In one set of embodiments, the database 620 can be a relational database, such as an Oracle database, that is adapted to store, update, and retrieve data in response to SQL-formatted commands. The database might be controlled and/or maintained by a database server, as described above, for example.

According to some embodiments, system 600 might further comprise a set-top box (“STB”) 625, one or more main display devices 630 each with display screen 630a, one or more user devices 635 each with user interface device 635a (which in some cases might include, without limitation, a touchscreen display, a keypad, a keyboard, or other user interface devices, or the like), one or more audio playback devices 640a-640n, one or more video content sources 645 and corresponding database(s) 650, one or more metadata sources 655 and corresponding database(s) 660, and/or the like.

In operation, the STB 625 might receive one or more first metadata, the one or more first metadata corresponding to one or more first video content available from a first video content source among a plurality of video content sources. The STB 625 might also receive one or more second metadata, the one or more second metadata corresponding to one or more second video content available from a second video content source among the plurality of video content sources, the second video content source being of a different type from that of the first video content source. The STB 625 might further compile the one or more first metadata and the one or more second metadata and generate a unified multi-source video programming and navigation guide (“UPG”) that lists in a blended fashion the one or more first video content and the one or more second video content, based at least in part on the one or more first metadata and the one or more second metadata, the UPG presenting the blended listing of the one or more first video content and the one or more second video content in a grid with at least one of channel, video content source, or video content along a first axis of the grid and with start times along a second axis of the grid. The STB 625 might also display the UPG on a display screen 630a of the display device 630.

These and other functions of the system 600 (and its components) are described in greater detail above with respect to FIGS. 1-4.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, with a computing system, one or more first metadata, the one or more first metadata corresponding to one or more first video content available from a first video content source among a plurality of video content sources;
receiving, with the computing system, one or more second metadata, the one or more second metadata corresponding to one or more second video content available from a second video content source among the plurality of video content sources, the second video content source being of a different type from that of the first video content source;
compiling, with the computing system, the one or more first metadata and the one or more second metadata;
generating, with the computing system, a unified multi-source video programming and navigation guide (“UPG”) that lists in a blended fashion the one or more first video content and the one or more second video content, based at least in part on the one or more first metadata and the one or more second metadata, the UPG presenting the blended listing of the one or more first video content and the one or more second video content in a grid with at least one of channel, video content source, or video content along a first axis of the grid and with start times along a second axis of the grid; and
displaying, with the computing system, the UPG on a display device.

2. The method of claim 1, wherein the computing system comprises one of a set-top box (“STB”), a digital video recording (“DVR”) device, a processor of the display device running a software application (“app”), a processor of a user device running an app, a server computer over a network, a cloud-based computing system over a network, a media player, or a gaming console.

3. The method of claim 1, wherein the display device comprises one of a television set, a smart television, a computer monitor, a laptop monitor, or a projection system.

4. The method of claim 1, wherein the plurality of video content sources comprises at least two of one or more video streaming sources, one or more video broadcast sources, one or more off the air (“OTA”) sources, one or more satellite television (“TV”) sources, one or more cable TV sources, or one or more third party video content sources.

5. The method of claim 1, wherein each of the one or more first metadata and the one or more second metadata is received by the computing system in response to one of a pull data distribution instruction or a push data distribution instruction.

6. The method of claim 1, wherein the UPG is updated or refreshed in response to a trigger, the trigger comprising one of power-up of the computing system, boot-up of the computing system, wake-up of the computing system, periodic update timer, or user request operator instruction.

7. The method of claim 1, further comprising:
receiving, with the computing system, first user input from a user, the first user input causing the UPG being displayed on the display device in a particular order or grouping;
updating, with the computing system, the UPG in accordance with the particular order or grouping; and
displaying, with the computing system, the updated UPG on the display device.

8. The method of claim 7, wherein the particular order or grouping is based on one of channel numbers, station names, genre groupings, favorites groupings, or a combination of one or more of channel numbers, station names, genre groupings, or favorites groupings.

9. The method of claim 1, further comprising:
receiving, with the computing system, second user input from a user, the second user input comprises a selection of a video content from among the blended listing of the one or more first video content and the one or more second video content of the UPG;
in response to receiving the second user input, determining, with the computing system, which video content source of the one or more first video content sources or the one or more second video content sources corresponds to the selected video content in accordance with the second user input;
based on the determined video content source, accessing, with the computing system, the selected video content from the determined video content source; and
displaying, with the computing system, the selected video content on the display device.

10. The method of claim 9, wherein receiving second user input from the user comprises receiving, with the computing system, the second user input from the user via one or more user devices, wherein the one or more user devices each comprises one of a laptop computer, a tablet computer, a smart phone, a mobile phone, a personal digital assistant, a remote control device, or a portable gaming device.

11. The method of claim 1, further comprising:
receiving, with the computing system, one or more third metadata, the one or more third metadata corresponding to one or more third video content available from a third video content source among the plurality of video content sources, the third video content source being of a different type from that of each of the first video content source and the second video content source;
compiling, with the computing system, the one or more first metadata, the one or more second metadata, and the one or more third metadata; and
wherein generating the UPG comprises generating, with the computing system, the UPG that lists in a blended fashion the one or more first video content, the one or more second video content, and the one or more third video content, based at least in part on the one or more first metadata, the one or more second metadata, and the one or more third metadata, the UPG presenting the blended listing of the one or more first video content, the one or more second video content, and the one or more third video content in the grid with at least one of channel, video content source, or video content along the first axis of the grid and with start times along the second axis of the grid.

12. An apparatus, comprising:
at least one processor; and
a non-transitory computer readable medium communicatively coupled to the at least one processor, the non-transitory computer readable medium having stored thereon computer software comprising a set of instructions that, when executed by the at least one processor, causes the apparatus to:
receive one or more first metadata, the one or more first metadata corresponding to one or more first video content available from a first video content source among a plurality of video content sources;
receive one or more second metadata, the one or more second metadata corresponding to one or more second video content available from a second video content source among the plurality of video content sources, the second video content source being of a different type from that of the first video content source;
compile the one or more first metadata and the one or more second metadata;
generate a unified multi-source video programming and navigation guide (“UPG”) that lists in a blended fashion the one or more first video content and the one or more second video content, based at least in part on the one or more first metadata and the one or more second metadata, the UPG presenting the blended listing of the one or more first video content and the one or more second video content in a grid with at least one of channel, video content source, or video content along a first axis of the grid and with start times along a second axis of the grid; and
display the UPG on a display device.

13. The apparatus of claim 12, wherein the apparatus comprises one of a set-top box (“STB”), a digital video recording (“DVR”) device, a processor of the display device running a software application (“app”), a processor of a user device running an app, a server computer over a network, a cloud-based computing system over a network, a media player, or a gaming console.

14. The apparatus of claim 12, wherein the display device comprises one of a television set, a smart television, a computer monitor, a laptop monitor, or a projection system.

15. The apparatus of claim 12, wherein the plurality of video content sources comprises at least two of one or more video streaming sources, one or more video broadcast sources, one or more off the air (“OTA”) sources, one or more satellite television (“TV”) sources, one or more cable TV sources, or one or more third party video content sources.

16. The apparatus of claim 12, wherein each of the one or more first metadata and the one or more second metadata is received by the computing system in response to one of a pull data distribution instruction or a push data distribution instruction.

17. The apparatus of claim 12, wherein the UPG is updated or refreshed in response to a trigger, the trigger comprising one of power-up of the computing system, boot-up of the computing system, wake-up of the computing system, periodic update timer, or user request operator instruction.

18. The apparatus of claim 12, wherein the set of instructions that, when executed by the at least one processor, causes the apparatus to:
receive first user input from a user, the first user input causing the UPG being displayed on the display device in a particular order or grouping;
update the UPG in accordance with the particular order or grouping; and
display the updated UPG on the display device.

19. The apparatus of claim 18, wherein the particular order or grouping is based on one of channel numbers, station names, genre groupings, favorites groupings, or a combination of one or more of channel numbers, station names, genre groupings, or favorites groupings.

20. The apparatus of claim 12, wherein the set of instructions that, when executed by the at least one processor, causes the apparatus to:
receive second user input from a user, the second user input comprises a selection of a video content from among the blended listing of the one or more first video content and the one or more second video content of the UPG;
in response to receiving the second user input, determine which video content source of the one or more first video content sources or the one or more second video content sources corresponds to the selected video content in accordance with the second user input;
based on the determined video content source, access the selected video content from the determined video content source; and
display the selected video content on the display device.

21. The apparatus of claim 20, wherein receiving second user input from the user comprises receiving, with the computing system, the second user input from the user via one or more user devices, wherein the one or more user devices each comprises one of a laptop computer, a tablet computer, a smart phone, a mobile phone, a personal digital assistant, a remote control device, or a portable gaming device.

22. The apparatus of claim 12, wherein the set of instructions that, when executed by the at least one processor, causes the apparatus to:
receive one or more third metadata, the one or more third metadata corresponding to one or more third video content available from a third video content source among the plurality of video content sources, the third video content source being of a different type from that of each of the first video content source and the second video content source;
compile the one or more first metadata, the one or more second metadata, and the one or more third metadata; and
wherein generating the UPG comprises generating the UPG that lists in a blended fashion the one or more first video content, the one or more second video content, and the one or more third video content, based at least in part on the one or more first metadata, the one or more second metadata, and the one or more third metadata, the UPG presenting the blended listing of the one or more first video content, the one or more second video content, and the one or more third video content in the grid with at least one of channel, video content source, or video content along the first axis of the grid and with start times along the second axis of the grid.

23. A system, comprising:
a computing system, comprising:
at least one first processor; and
a first non-transitory computer readable medium communicatively coupled to the at least one first processor, the first non-transitory computer readable medium having stored thereon computer software comprising a first set of instructions that, when executed by the at least one first processor, causes the computing system to:
receive one or more first metadata, the one or more first metadata corresponding to one or more first video content available from a first video content source among a plurality of video content sources;
receive one or more second metadata, the one or more second metadata corresponding to one or more second video content available from a second video content source among the plurality of video content sources, the second video content source being of a different type from that of the first video content source;
compile the one or more first metadata and the one or more second metadata;
generate a unified multi-source video programming and navigation guide (“UPG”) that lists in a blended fashion the one or more first video content and the one or more second video content, based at least in part on the one or more first metadata and the one or more second metadata, the UPG presenting the blended listing of the one or more first video content and the one or more second video content in a grid with at least one of channel, video content source, or video content along a first axis of the grid and with start times along a second axis of the grid; and
send the UPG to a display device; and
the display device, comprising:
a display screen;
at least one second processor; and
a second non-transitory computer readable medium communicatively coupled to the at least one second processor, the second non-transitory computer readable medium having stored thereon computer software comprising a second set of instructions that, when executed by the at least one second processor, causes the display device to:
receive the UPG from the computing system; and
display the UPG on the display screen.

24. The system of claim 23, wherein the computing system comprises one of a set-top box (“STB”), a digital video recording (“DVR”) device, a processor of the display device running a software application (“app”), a processor of a user device running an app, a server computer over a network, a cloud-based computing system over a network, a media player, or a gaming console.
